(19) United States
(12) Patent Application Publication
(10) Pub. No.: US 2026/0360975 A1
(43) Pub. Date: Nov. 12, 2026

(54) IMPROVED TERAHERTZ REFLECT ARRAYS AND RELATED METHODS

(71) Applicant: CAMBRIDGE TERAHERTZ, INC., Santa Clara, CA (US)

(72) Inventors: Nathan Mckay MONROE, Santa Clara, CA (US); Refael WHYTE, Santa Clara, CA (US)

(21) Appl. No.: 19/491,173

(22) PCT Filed: Jun. 8, 2024
(86) PCT No.: PCT/US2024/033171

§ 371 Date: Dec. 8, 2025

Related U.S. Application Data
(60) Provisional application No. 63/507,219, filed on Jun. 9, 2023.
(60) Provisional application No. 63/507,229, filed on Jun. 9, 2023.
(60) Provisional application No. 63/507,236, filed on Jun. 9, 2023.

(51) Int. Cl. H01Q 3/36; G01S 7/35; H01Q 1/22

(52) U.S. Cl. CPC H01Q 3/36; G01S 7/35; H01Q 1/2283

(57) ABSTRACT

Improvements to terahertz imaging systems and related methods of using same are disclosed. In terahertz imaging systems comprising a terahertz antenna array made up of a plurality of antenna elements each with a patch antenna and a one bit phase shifter, the phase pattern applied by each phase shifter may switch such that the reflectarray itself may act as a mixer in the signal path. Such reflect arrays may be advantageously implemented with flip-chip packages with passive resonators, and a processing unit may co-located with each patch antenna to calculate the appropriate drive signal to the phase shifter.

### I. PRIORITY CLAIM

The present invention claims priority from U.S. Provisional Application No. 63/507,219, filed Jun. 9, 2023, U.S. Provisional Application No. 63/507,229, filed Jun. 9, 2023, and U.S. Provisional Application No. 63/507,236, filed Jun. 9, 2023, the disclosures of which are hereby incorporated by this reference in their entireties.

### II. FIELD OF THE INVENTION

The inventions of this disclosure comprise improvements to high angular resolution beam steering terahertz antenna arrays, and in particular, reflectarrays.

### III. BACKGROUND

One illustrative reflectarray radar design in which aspects of the instant disclosure may be implemented is depicted in FIGS. 1-2. As shown in FIG. 1, the device comprises a transceiver and reflectarray. In the transceiver, a transmit (TX) signal is split into transmit and receive pathways, and in each case to the input of a driver. The output of the driver in the transmit pathway is connected to a duplexer (represented as a Wilkinson power combiner in this case) and thereby to a feed point of the reflectarray, which comprises a plurality of antenna elements.

The incident wave is reflected by the reflectarray in a direction of interest, where it may encounter one or more objects and be reflected back toward the reflectarray. Waves reflected back toward the reflectarray are directed to the duplexer and thereby to the receive pathway and associated processing.

Each antenna element of the reflectarray may comprise a phase shift circuit. In one embodiment, the phase shift circuit may be a one-bit phase shifter as depicted in FIG. 2. In the one-bit phase shifter of FIG. 2, the signal D controls two switches comprising for example, complementary metal-oxide semiconductor (CMOS) field effect transistors. In this embodiment, a logic high on signal D activates the switch that connects P1 to P2, and conversely, a logic low on signal D activates the switch that connects P1 to P3. The one-bit phase shifter embodiment of FIG. 2 changes the phase with which an incident wave is reflected. The reflected wave has a relative phase shift of 180 degrees depending on whether D is logic high or logic low.

Antenna elements may also comprise memory to store certain phase shift values to be applied at certain times. Those of ordinary skill in the art will understand that the reflectarray device illustrated in FIGS. 1-2 are only one embodiment in which the inventions of this disclosure may be implemented and do not limit the following teachings. The teachings of this disclosure are applicable to other means of phase shifting and reflectarrays implemented with different or additional technologies.

### IV. BRIEF SUMMARY OF THE INVENTION

In one aspect, the inventions of this disclosure comprise a method of modulating the phase pattern applied to a reflectarray imaging radar during sampling of a single pixel. By switching between phase patterns that maintain the direction and magnitude associated with the current pixel but change the phase of the radiation pattern, the reflectarray may act as a mixer and produce an output at a reduced intermediate frequency (IF).

In another aspect, the inventions of this disclosure comprise Terahertz (THz) reflectarray patch antennas fabricated in flip chip (or controlled collapse chip connection) packages and the inclusion of passive resonators in or on the board to which such packages are attached. Such an approach solves two issues concerning the assembly and performance of integrated circuit-based THz reflectarrays.

In another aspect, the inventions of this disclosure include locating a processing unit near or within an antenna element of the reflectarray. With a processing unit co-located with a patch antenna, computations performed to calculate each antennas' phase state may be made in realtime on-chip, rather than being pre-computed and loaded onto an on-chip memory.

### V. BRIEF DESCRIPTIONS OF THE DRAWINGS

FIG. 1 depicts an illustrative reflectarray radar design in which aspects of the instant disclosure may be implemented.

FIG. 2 exemplary design of a one-bit phase shifter associated with a single patch antenna of the reflectarray.

FIG. 3a shows a sample radar output without range gating.

FIG. 3b shows a sample radar output with range gating via local oscillator in the output path.

FIG. 4 shows a mixer placed in the radar output signal path for range gating, where the exemplary radar output signal path includes a 625 megahertz (MHz) local oscillator, mixer, variable gain amplifier, analog-to-digital converter (ADC) operating at 15 mega-samples per second (MSPS), and a computer for processing.

FIG. 5 shows a one-bit reflectarray phase pattern for a certain instance of beam steering (left), and its inverted state (right). Black squares represent antennas with a phase state of 0°, and white squares represent antennas with a phase state of 180°, resulting in exact inversion of the two patterns.

FIG. 6 depicts an exemplary radiation pattern magnitude of the reflectarray, applicable in both cases of phase patterns from FIG. 5.

FIG. 7 depicts exemplary radiation pattern phases of the reflectarray associated with the two configurations in FIG. 5, showing that, in all directions, the two sets of phases have a 180-degree difference between them.

FIG. 8 depicts the phase modulation term applied to the radar output IF signal resulting from reflectarray pattern inversions.

FIG. 9 depicts a typical CMOS cross section.

FIG. 10 depicts simulation data showing typical radiation efficiencies for a 300 gigahertz (GHz) patch antenna in a CMOS process, as a function of the separation distance between the patch antenna's radiating element and ground.

FIG. 11a depicts wirebond connections for chip-chip and chip-board interconnect.

FIG. 11b depicts a flip-chip assembly.

FIG. 11c depicts a flip-chip assembly with passive radiators.

FIG. 12 depicts an antenna array chip with input-output (I/O) pads arranged around the periphery.

FIG. 13 depicts an array of chips.

FIG. 14 depicts a metallized printed circuit board (PCB) to host the array of chips.

FIG. 15 depicts a side view of flip chip antenna array on superstrate PCB.

### VI. DESCRIPTION OF THE INVENTION

### A. Range Gating

The inventions of this disclosure comprise, in one aspect, a method of modulating the phase pattern applied to a reflectarray imaging radar during sampling of a single pixel. By switching between phase patterns that maintain the direction and magnitude associated with the current pixel but change the phase of the radiation pattern, the reflectarray may act as a mixer and produce an output at a reduced intermediate frequency (IF).

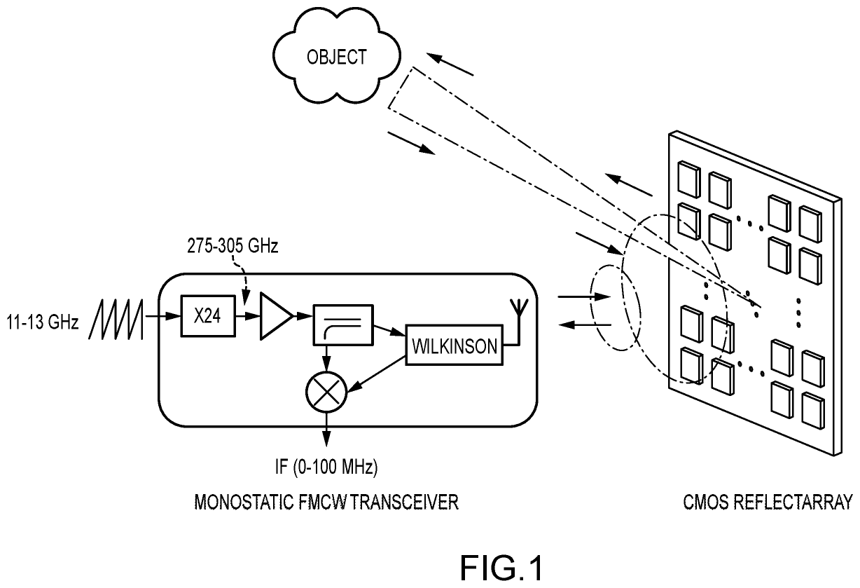

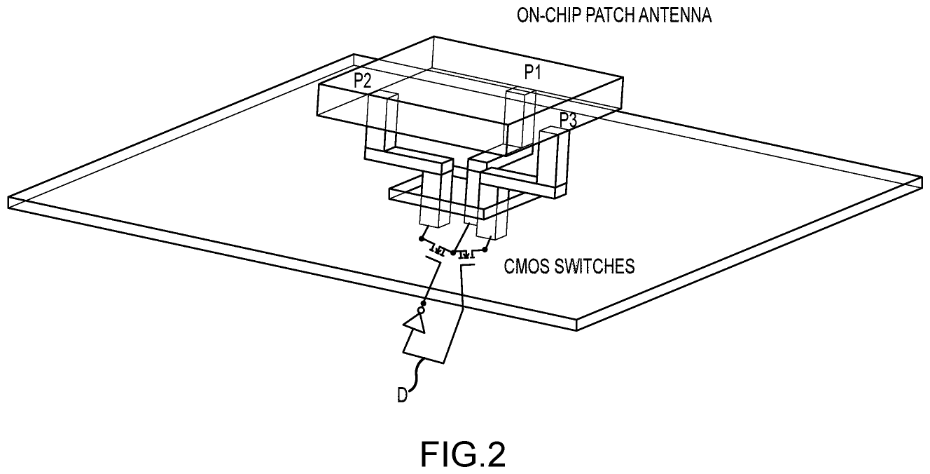

In modern reflectarray-based terahertz frequency modulated continuous wave (FMCW) imaging radars, a single transceiver is used to generate an image one pixel (or few pixels) at a time in a single-in, single-out (SISO) fashion. See FIG. 1. A single transceiver is preferred due to constraints in building dense transceiver arrays.

A typical useful image resolution of such a reflectarray radar might be, for example, 200×400 pixels. At ten frames per second, a reflectarray radar with this resolution would sample nearly one million pixels per second. Because each pixel is sampled serially, the maximum allowable integration time per pixel in such a design is on the order of 1 microsecond.

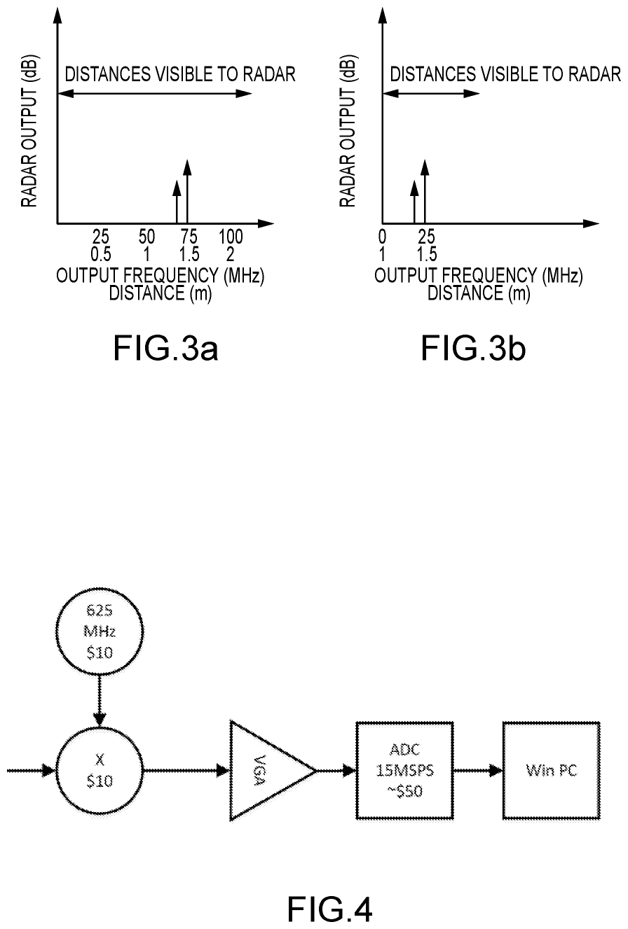

Simultaneously, range resolution requirements are often finer than 5 mm, which translates to a chirp bandwidth of 30 GHz. The requirement to chirp over a wide bandwidth in a short time yields very high chirp ramp rates in excess of 30 GHz/us and therefore very high frequencies at the radar's output, often in the hundreds of MHz or GHz for targets within tens of meters. See FIG. 3a. High output frequencies place constraints on downstream analog to digital converters (ADCs) and signal processing paths, adding cost, complexity and power consumption while also reducing noise performance.

A mixer placed in the radar output signal path can perform a “range gating” function by mixing the radar's output signal down to a lower frequency, as seen in FIG. 4. Mixing the output signal in this way relaxes the constraints on the ADC and downstream signal processing. However, it comes at the expense of reducing the widow of possible ranges which are visible to the radar, as seen in FIG. 3b. The addition of the range gating mixer (and associated local oscillator) add cost, power, complexity, phase noise, and other nonidealities. In addition, common target scenes have abrupt changes in target distance, requiring rapid changes in range gating configuration and therefore rapid changes in the range gating mixer's Local Oscillator frequency. Settling times in the mixer's local oscillator increase the time required to change range gating configurations, reducing imaging speed and introducing significant complexity at the system level.

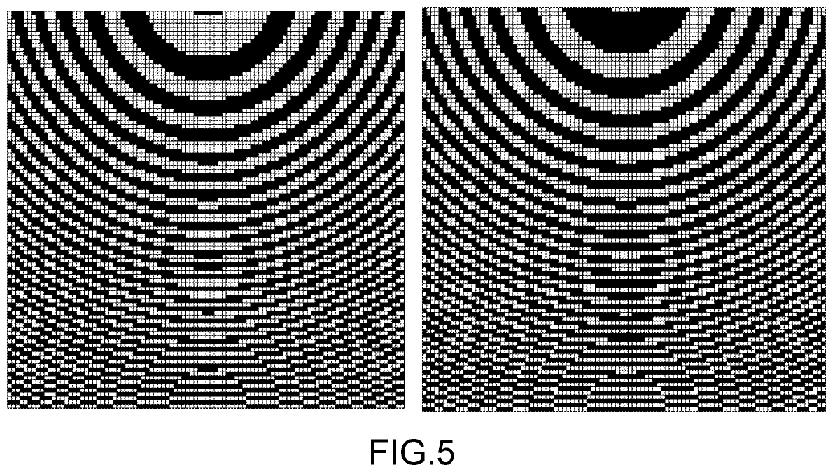

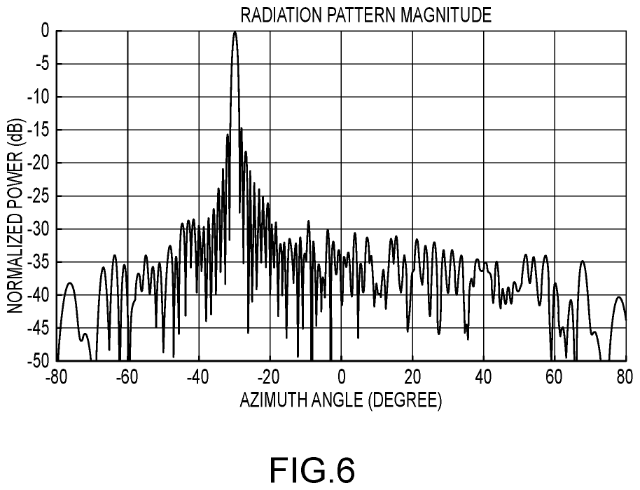

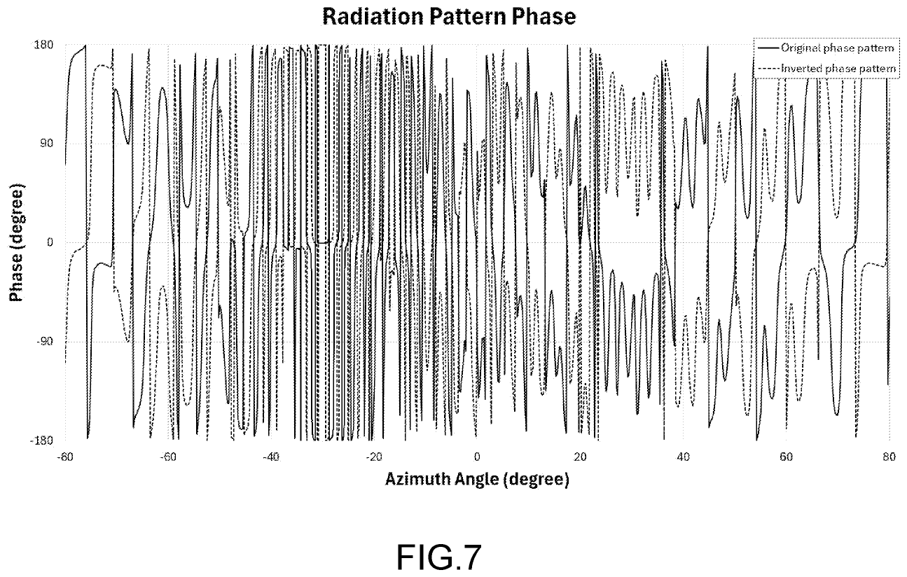

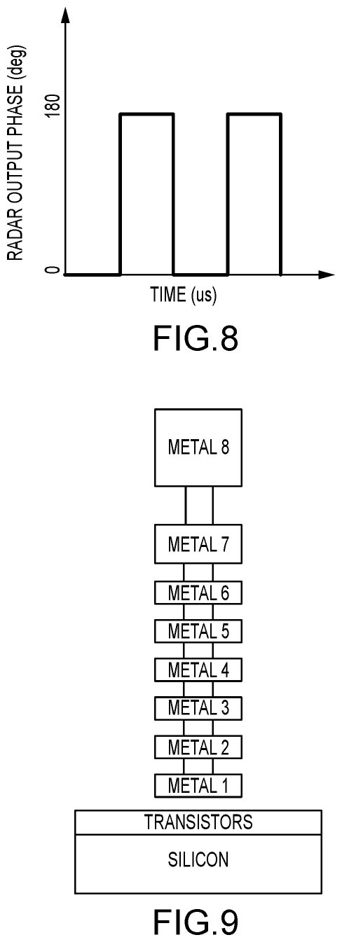

In the reflectarray design described above and depicted in FIG. 1, this mixing function can alternatively be performed by the reflectarray itself by modulating the phase pattern of the array. In normal operation, the phases of the antenna in the reflectarray alter the radar's intermediate frequency (IF) output by changing the direction to which the radar is sensitive. However, the reflectarray's phases can also be used to apply modulation to the radar's IF output while preserving the direction of the radar's sensitivity. In one incarnation with one-bit phase quantization, the array's phases are repeatedly altered between a first state and the inversion of the said first state, as illustrated by FIG. 5. The direction and magnitude associated with the current pixel to be sampled are preserved between the first state and its inversion (see FIG. 6), while the two states have radiation pattern phases which are 180 degrees relative to one another (see FIG. 7). Therefore, by rapidly switching between the two states, a square wave modulation is applied in the phase of the radar's output signal, as seen in FIG. 8. Appropriate values of the modulation frequency can allow the reflectarray to serve as the range gating mixer. This approach reduces part count, cost, complexity, power, and phase noise. It also eliminates settling time issues, enabling the radar imager to have agility in accepting a wide range of distances simultaneously.

As one example, with a 30 GHz chirp over 1 us and a target at 2 meters in a monostatic radar configuration, switching the phase-shift pattern applied to the reflectarray between a first state associated with the current pixel to be sampled and the inverse of the first state at a frequency of 25 MHz results in an IF of 25 MHz and a range of useful sensing distances of 1-1.5 meters for an ADC with a sampling rate of 50 MSPS.

### B. Flip Chip Packaging With Passive Resonators

The inventions of this disclosure may also comprise Terahertz (THz) reflectarray patch antennas fabricated in flip chip (or controlled collapse chip connection) packages and the inclusion of passive resonators in or on the board to which such packages are attached. Such an approach solves two issues concerning the assembly and performance of integrated circuit-based THz reflectarrays.

### 1. Shortcomings of Existing Reflectarray Designs

Performance Limitations in Existing Designs. In integrated circuit (IC) antenna array with on-chip antennas, on-chip patch antennas are often employed using the metal layers in a CMOS process backend, with lower metal layers used as ground and upper metal layers used as the radiating element. An example cross section of a CMOS process can be seen in FIG. 9.

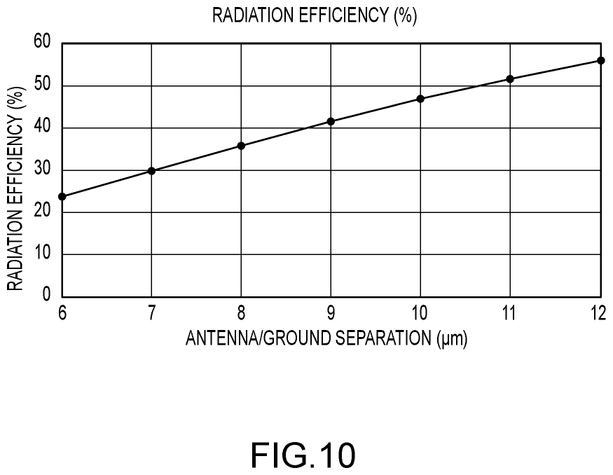

For such patch antennas, the radiation efficiency is closely related to the distance between the radiating element and the lower ground plane, with a larger distance corresponding to a higher efficiency, as seen in simulation data in FIG. 10. In real on-chip antennas, this distance is limited by manufacturing constraints, leading to typical efficiencies around 25% (−6 dB). When such antennas are applied in reflectarrays with monostatic radar configuration, this radiation efficiency penalty is seen four times, with a total loss of 24 dB, or more than 99.6%. In imaging applications, this directly manifests in degraded Signal-to-Noise Ratio (SNR), requiring an integration time on the order of 250 times longer for the same SNR as compared to an ideal antenna. Increased integration time directly manifests in reduced imaging framerates by the same factor.

In addition, on-chip antennas suffer limited bandwidth, often approximately 3%, or 10 GHz at a center frequency of 300 GHz. Limited bandwidth directly manifests in reduced range resolution, with many applications requiring 5 mm of range resolution, translating to 30 GHz of bandwidth.

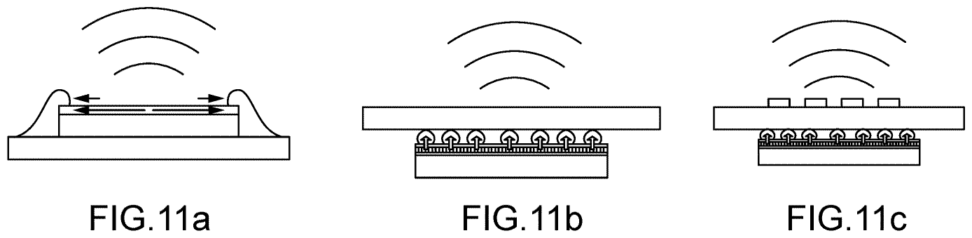

Assembly Issues in Existing Designs. When these arrays are implemented using tiled CMOS chips, it is necessary to connect adjacent chips for signaling and power, often with hundreds of chips and thousands of interconnects. Wirebond-style connections, seen in FIG. 11a, are expensive and poor yielding and difficult to scale at volume.

### 2. Description of a New and Improved Reflectarray Design

In these proposed devices and methods, flip-chip assembly is utilized to address the two issues described above. Flip-chip packaging and processes enables rapid assembly with connections made in parallel, as seen in FIG. 11b. Simultaneously, flip chip packaging and assembly addresses the antenna efficiency and bandwidth issues summarized above.

Because on-chip antennas are implemented in top CMOS metal layers with topside radiation, flip chip packaging necessitates the fact that THz energy is radiated through the superstrate material the chips are flip chipped onto, and this superstrate material and geometry must be chosen carefully. Applicant's simulation data has shown that by patterning this superstrate material with passively radiating and appropriately shaped metal structures which are electromagnetically coupled to the on chip antennas, the effective distance between the radiating element and ground can be increased. The result is an improvement in antennas' radiation performance from ~25% to in excess of 90%, while bandwidth can be improved from ~3% (10 GHz) to in excess of 12% (40 GHz). This solves all issues simultaneously, providing a low-cost, high-yielding and scalable assembly. Passively radiating metal structures can be located on the same side of the substrate material as the chips, the opposite side, integrated within the superstrate material, or any combination of the above.

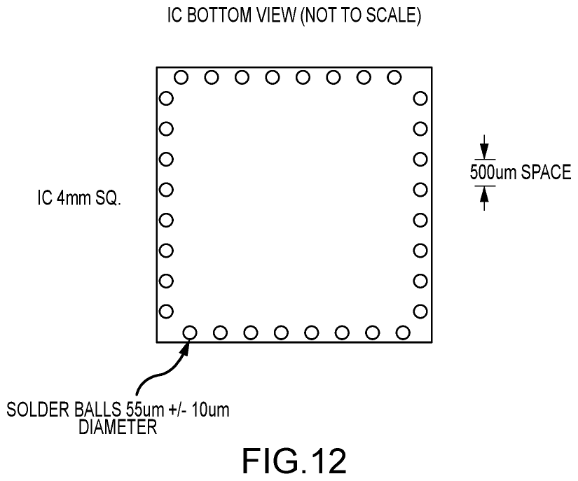

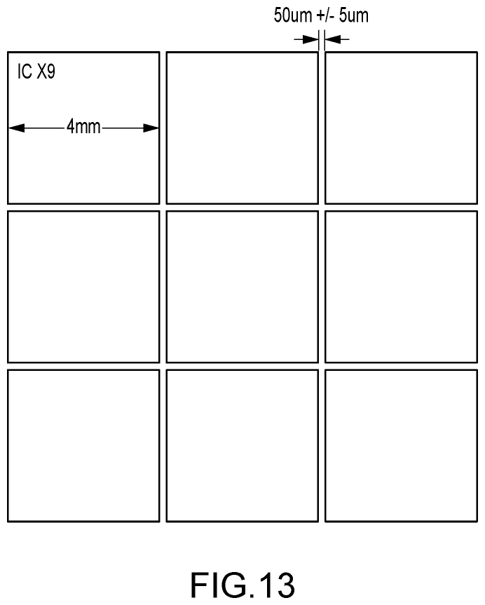

In the proposed approach, the IC with on-chip antennas has input/output (I/O) pads arranged around its periphery, as seen in FIG. 12, and a plurality of such chips are arranged in an array, as seen in FIG. 13.

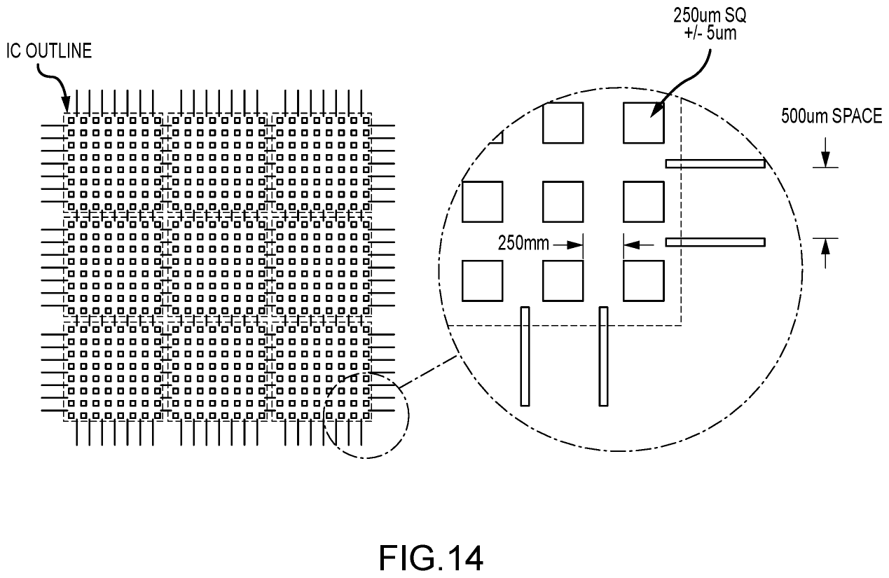

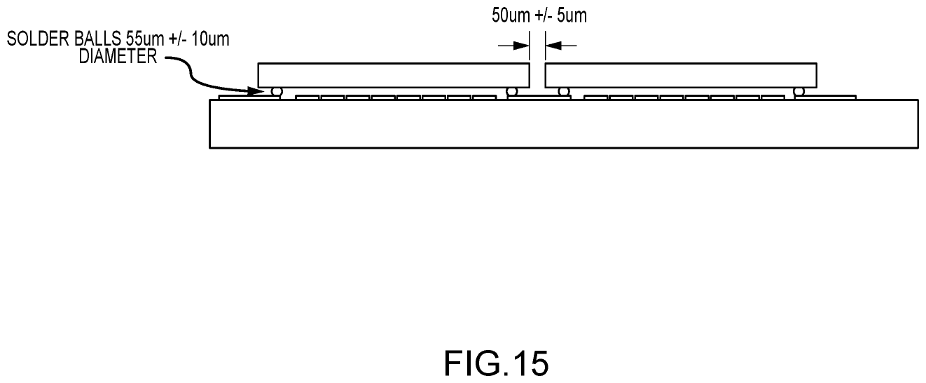

FIG. 14 depicts the superstrate printed circuit board (PCB) which hosts the array of chips, depicting the metallization which is used for both interconnect between chips (the lines) and the passively radiating structures (the squares). The associated side view can be seen in FIG. 15.

The superstrate PCB material could be a standard RF PCB material such as those made by Rogers Corporation, or alternatively, alumina, glass or quartz materials in some incarnations. A plurality of metallic shapes on the PCB, which serve as passive radiators, can assume multiple shapes. In some shapes, slots or cuts are made into the passively radiating metal structure to improve efficiency, bandwidth or coupling performance.

### C. Co-Located Computational and Antenna Elements

In CMOS-based large antenna arrays, realtime imaging requires rapid switching of beam states, which necessitates impractically large digital bandwidths to control phase states for the antenna array. Such requirements are often in excess of 10 Gbps for realtime imaging with reasonable frame rates, a data rate that introduces severe challenges on system power and performance. The computation ability that comes with CMOS processing can address this. CMOS THz antenna arrays with certain configurations (such as applicant's) leave significant amounts of silicon and routing resources available for use to be applied to this control bandwidth problem. Existing reflectarray designs utilized these resources for on-chip memory, such that each antenna locally stores a library of pre-computed beam states which are loaded onto the array's on-chip memory at startup.

In systems with limitations on startup time, there is still an excessively large digital bandwidth required at system startup to load these precomputed beam states from external nonvolatile memory onto the array. With reasonable assumptions, this loading operation may result in a startup time measured in tens of minutes. This latency may be addressed with the employment of on-chip nonvolatile memory, where such data is loaded one time onto the array and exists on the array forever, however nonvolatile capabilities are expensive and not available in every IC process.

An additional issue exists due to the amount of memory required to store the necessary phase control data on-chip. In designs where the antenna is on-chip, sufficient silicon area exists to implement the necessary on-chip memory. However, in certain incarnations the antenna element is moved off-chip and onto an external package. In such an incarnation, the chip contains only phase shifter elements and associated passive components. This potentially enables a large improvement in antenna performance and a reduction in the requisite silicon area (and therefore cost) by approximately 80%. However, a reduction in silicon area by 80% reduces the amount of available on-chip memory by the same amount, reducing the amount of available on-chip memory to unacceptable levels. This 80% cost reduction is not compatible with the on-chip memory approach.

A device and method herein described addresses this bandwidth challenge and the memory silicon area limitations by locating a processing unit near or within an antenna element of the reflectarray. With a processing unit co-located with a patch antenna, computations performed to calculate each antennas' phase state may be made in realtime on-chip, rather than being pre-computed and loaded onto an on-chip memory.

In this method, computation circuits replace the local on-chip memory so that each antenna locally computes the required phases for beam steering, rather than using on-chip memory to store externally pre-computed beam states. Each antenna locally contains computation circuits executing a local model of the reflectarray system capable of calculating its own required phase in realtime.

In such an implementation, on system startup, each antenna is loaded with a small number of bits (perhaps on the order of 200) to communicate its physical location within the reflectarray and the system geometrical parameters. Subsequently, in operation mode, the desired beam direction (a ~16 bit number) is communicated to each antenna simultaneously. On-chip computation circuits within each antenna may use this information to calculate the antenna's specific phase state, with each antenna operating simultaneously in parallel. Performing calculations at each antenna element reduces the startup bandwidth requirement to a negligible amount and operation-time bandwidth to an acceptable amount (~16 MHz), and reduces the chip area requirement to negligible amounts which are compatible with future cost-reduced versions employing off-chip antennas.

### D. Full Wafer Array

In large array sizes, reflectarrays are implemented by designing a CMOS chip such that it can communicate with copies of itself, and tiling many copies of such chips into a large array. The related dicing and assembly process adds unnecessary steps due to the labor, equipment, required tolerances and yield issues. In reality, it is much more efficient to use full wafer techniques to create large antenna arrays. In this technique, a full reticle is filled with antenna array circuits, and a wafer is fabricated filled with such reticles. A low cost and low fidelity post-processing step performed on the wafer stitches adjacent reticles, yielding an antenna array with much simpler and cheaper assembly.

### E. Handheld Imaging Device

The improvements of the instant disclosure may enable not only cost-and power-savings but also miniaturization to a point where a reflectarray with an integrated transceiver in a monostatic radar configuration may be manufactured in a handheld form factor for portable THz imaging.

The foregoing exemplary descriptions and the illustrative embodiments of the present disclosure have been explained in the drawings and described in detail, with varying modifications and alternative embodiments being taught. While the disclosure has been so shown, described and illustrated, it should be understood by those skilled in the art that equivalent changes in form and detail may be made therein without departing from the true spirit and scope of the disclosure. Wherever the disclosure or the claims use the term processor, that term should be understood to refer to a microprocessor, a microcontroller, a Field Programmable Gate Array (FPGA), and other types of programmable logic.

1. A device comprising
a transceiver comprising a signal splitter, a transmit pathway, and a receive pathway, wherein the signal splitter splits a transmit signal and connects said transmit signal to each of the transmit pathway and the receive pathway; and
a reflectarray comprising a plurality of antenna elements, each antenna element further comprising a radiating element and a phase shift circuit, wherein each radiating element of the plurality of antenna elements is fabricated in a top layer of one or more semiconductor chips, each of the one or more semiconductor chips is packaged in a flip-chip package such that the top layer of each semiconductor chip is proximate to a first side of the flip-chip package upon which a plurality of pads for electrical connection are located, and each flip-chip package is electrically connected to a first side of a superstrate material via said plurality of pads on said first side of the flip-chip, such that each radiating element is configured to radiate through the superstrate material.

2. The device of claim 1 further comprising one or more passively radiating structures in mechanical communication with the superstrate material.

3. The device of claim 2 wherein the one or more passively radiating structures comprise a plurality of metal structures which are electromagnetically coupled to one or more of the radiating elements of the reflectarray.

4. The device of claim 3 wherein the plurality of metal structures are fabricated upon the first side of the superstrate material.

5. The device of claim 3 wherein the plurality of metal structures are fabricated upon a second side of the superstrate material wherein the second side of the superstrate material is an opposite side from the first side of the superstrate material.

6. The device of claim 3 wherein
one or more of the plurality of metal structures are fabricated upon the first side of the superstrate material,
one or more of the plurality of metal structures are fabricated upon a second side of the superstrate material wherein the second side of the superstrate material is an opposite side from the first side of the superstrate material, and
one or more of the plurality of metal structures are fabricated within the superstrate material.

7. The device of claim 1, wherein the transmit pathway further comprises a transmit driver and a duplexer, and the transmit pathway is configured to communicate the transmit signal, first, to an input of the driver, second, from an output of the driver to an input of the duplexer, and third, to a feed point of the reflectarray.

8. The device of claim 7, wherein the reflect array is configured to receive a transmit signal from the feed point, reflect said transmit signal in a direction of interest, receive reflected signals which are reflected back from the direction of interest, and direct such reflected signals to the duplexer.

9. The device of claim 8, wherein the receive pathway further comprises a signal mixer, and the receive pathway is configured to
receive the transmit signal from the signal splitter,
receive signal from the reflectarray via the duplexer, and
mix the transmit signal and the receive signal with the signal mixer.

10. The device of claim 8, wherein each antenna element further comprises a processing unit co-located near the phase shift circuit.

11. The device of claim 10, wherein each processing unit is configured to compute a phase to be applied to the radiating element with which the processing unit is associated in order to steer an electromagnetic beam from the transmit signal received from the feed point in the direction of interest.

12. The device of claim 11, wherein each processing unit is configured to compute the phase to be applied based upon a local model of the reflect array system.

13. The device of claim 12, wherein each processing unit is configured to compute the phase to be applied based upon parameters including the physical location of the radiating element with which the processing unit is associated within the reflect array and the geometrical parameters of the reflectarray.

14. The device of claim 13, wherein each processing unit is configured to compute, in realtime, a sequence of a plurality of phases to be applied to the radiating element with which the processing unit is associated to steer the electromagnetic beam in a time-varying sequence of directions of interest.

15. The device of claim 1, wherein each a phase shift circuit is a one-bit phase shifter comprising a control signal, an inverter, a first switch, and a second switch wherein the control signal drives an input of the first switch and the inverter and the output of the inverter drives the second switch.

16. The device of claim 15, wherein each of the first and second switch comprises a field effect transistor and the inputs of said switches are the gates of said field effect transistors.

17. The device of claim 1, wherein the plurality of antenna elements are fabricated within a single semiconductor substrate.

18. The device of claim 8, further comprising a processor wherein the device is configured to sample a value associated with the direction of interest and the processor is configured to apply a phase pattern to the reflectarray by signaling to each of the plurality of antenna elements a parameter comprising a phase shift to be applied by the phase shift circuit in that antenna element to the radiating element of that antenna element such that the radiating elements in the plurality of antenna elements produces a reflected radiation pattern associated with the direction of interest when the reflect array receives the transmit signal from the feed point.

19. The device of claim 18, wherein the processor is further configured to modulate the phase pattern applied to the reflectarray during said sampling such that the direction and magnitude of the reflected radiation pattern are maintained constant but the phase of the reflected radiation pattern is switched between two states wherein the reflectarray acts as a mixer and produces an output signal from the reflected signal at a reduced intermediate frequency.
